(19) United States
(12) Patent Application Publication
(10) Pub. No.: US 2017/0039671 A1
(43) Pub. Date: Feb. 9, 2017

(54) ROBOTIC SELF-FILMING SYSTEM

(71) Applicants: Seoul National University R&DB Foundation, Seoul (KR); Selvidea Co., Ltd, Seoul (KR)

(72) Inventors: Seung-Woo Seo, Seoul (KR); Seong-Woo Kim, Seoul (KR)

(21) Appl. No.: 14/820,950

(22) Filed: Aug. 7, 2015

(51) Int. Cl. G06T 1/00; B25J 9/16; H04N 5/232

(52) U.S. Cl. CPC G06T 1/0014; H04N 5/23229; B25J 9/1679; B25J 9/1697; Y10S 901/02; Y10S 901/30

(57) ABSTRACT

In general, embodiments of the present invention relate to a robotic self-filming system. Specifically, the robotic self-filming system includes a base, robot arm, video recording device holder, a video recording device mounted on the video device holder, and a robot control unit. The robot control unit receives video data from the video recording device. Using the video data, the robot control unit detects an object and tracks the object as the object moves freely about the environment. The robotic self-filming system then produces a final video product based on the video data and predefined parameters.

### TECHNICAL FIELD

The present invention relates to a robotic self-filming system. Specifically, a robotic self-filming system for automatically moving a video recording device position during video recording of a freely moving object is disclosed.

### BACKGROUND

Video recording a person participating in an activity is an increasingly popular task. A competitive softball pitcher may wish to capture her game play for later enjoyment or to improve her pitching technique. A father may wish to record his son's winning touchdown in a football game. A mother may wish to capture her daughter's record-breaking gymnastics performance. To record the object, a second person is usually needed to control and position the video recording device. Because humans are imperfect, the quality of the recorded video may not be ideal. For example, the camera operator may have an unsteady hand making the recorded video too shaky and difficult to watch. Additionally, the camera operator may become tired or distracted and may not keep the object in the view field of the video recording device. In this situation, the camera operator may fail to capture an exciting or interesting moment. Further, some objects may not have a second person willing to operate the video recording device. In this case, the individual loses the chance to record him or herself.

### SUMMARY

In general, embodiments of the present invention relate to a robotic self-filming system. Specifically, the robotic self-filming system includes a base, robot arm, video recording device holder, a video recording device mounted on the video device holder, a robot control unit, and a communication unit. The robot control unit includes a control module that sends out control signals for controlling the movement of a robot arm; an object detection module that detects an object from the video data taken by the video recording device; a object tracking module that tracks the object; a communication unit that downloads a set of application and control software from a web server; and a user interface module that receives parameter values from a user. Through the communication unit, the user of a robotic self-filming system can download all of the control software including the pre-designed composition styles and detection and tracking algorithms from a web server. In addition, necessary parameters can be set through the user interface module. Using the video data, the robot control unit detects an object and tracks the object as the object moves freely about the environment. The robotic self-filming system then produces a final video product based on the video data and predefined parameters.

One aspect of the present invention provides a method for recording a video using a robotic self-filming system, the method comprising: receiving video data from a video recording device; detecting an object based on the video data; determining a composition style; tracking the object based on the video data; and communicating a movement request to the robotic self-filming based on the tracking and the composition style.

A second aspect of the present invention provides robotic self-filming system, comprising: a robotic self-filming apparatus having: a base; a robot arm; and a video recording device holder configured to hold a video recording device; and a robot control unit, configured to: receive video data from the video recording device; detect an object based on the video data; determine a composition style; track the object based on the video data; and communicate a movement request to a robotic self-filming apparatus based on the tracking and the composition style; and a communication unit, configured to communicate with a server for performing at least one of downloading control software or uploading a video.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computerized implementation according to an example embodiment of the present invention;

FIG. 2 shows a schematic diagram illustrating a robotic self-filming system according to an example embodiment of the present invention;

FIGS. 3A-B show schematic diagrams illustrating example graphical user interfaces according to embodiments of the present invention;

FIGS. 4A-B show schematic diagrams illustrating removal of a video recording device from a video recording device holder according to example embodiments of the present invention;

FIG. 5 shows a schematic diagram illustrating a robotic self-filming base according to an example embodiment of the present invention;

FIG. 6 shows a schematic diagram illustrating a robot control unit of a robotic self-filming apparatus according to an example embodiment of the present invention;

FIG. 7 shows a flow diagram illustrating a method for video recording using a robotic self-filming apparatus (RSFA) according to an example embodiment of the present invention; and

FIGS. 8A-B show schematic diagrams illustrating video processing according to example embodiments of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the embodiments set forth herein. Rather, these illustrative embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention relate to a robotic self-filming system. Specifically, the robotic self-filming system includes a base, robot arm, video recording device holder, a video recording device mounted on the video device holder, and a robot control unit. The robot control unit receives video data from the video recording device. Using the video data, the robot control unit detects an object and tracks the object as the object moves freely about the environment. The robotic self-filming system then produces a final video product based on the video data and predefined parameters.

The system described herein generally comprises two substantially separate units: a portable but substantially stationary unit that executes the functions of a positioning device and a video recording device (e.g., camera, smartphone, etc.) and an interface device that may be controlled by an object of the video recording. In various preferred embodiments, these functions may be carried out by separate units or by integrated units.

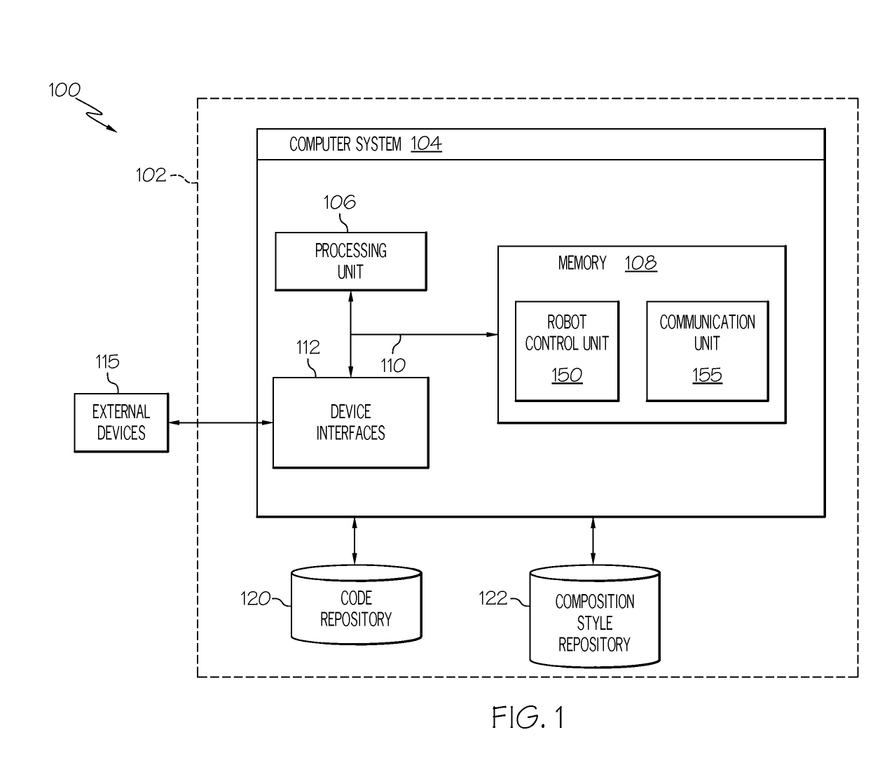

FIG. 1 depicts a computerized implementation 100 according to an embodiment of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communication links. For example, the communication links can comprise addressable connections that may utilize any combination of wired and/or wireless transmission methods. Where communication occurs via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing a robotic self-filming system according to the present invention. It should be understood that any other computers implemented under the present invention may have different components/software, but will perform similar functions. As shown, computer system 104 includes a processing unit 106, memory 108 for storing a robot control unit 150 and a communication unit 155, a bus 110, and device interfaces 112.

Processing unit 106 collects and routes signals representing outputs from external devices 115 (e.g., a keyboard, a pointing device, a display, a graphical user interface, etc.) to robot control unit 150. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG).)

In general, processing unit 106 executes computer program code, such as program code for operating robot control unit 150 and communication unit 155, which is stored in memory 108 and/or code repository 120. While executing computer program code, processing unit 106 can read and/or write data to/from memory 108, code repository 120 and/or composition style 122. Code repository 120 and/or composition style repository 122 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

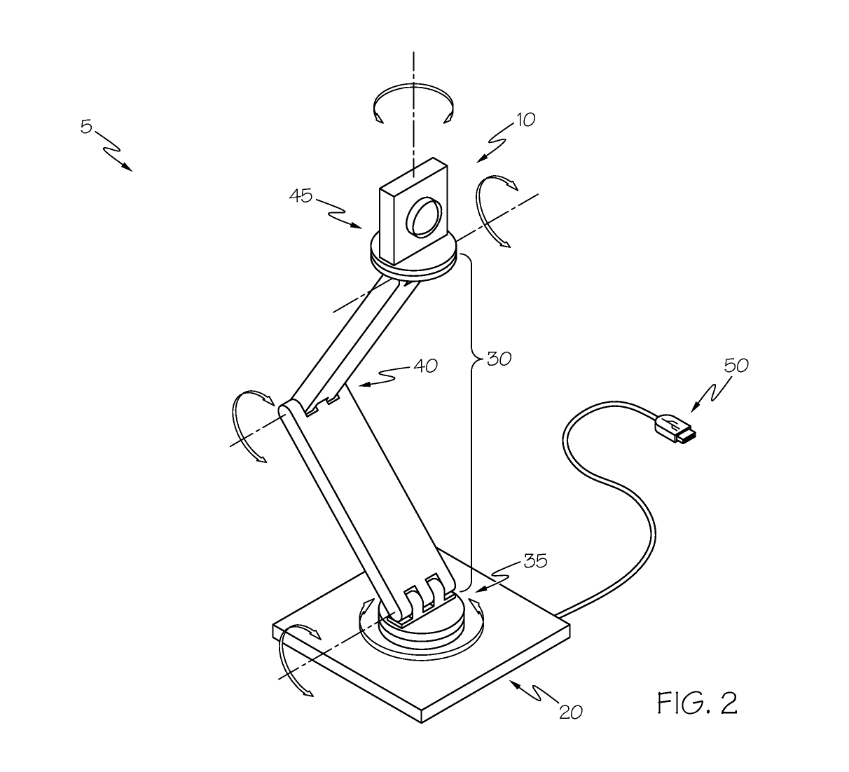

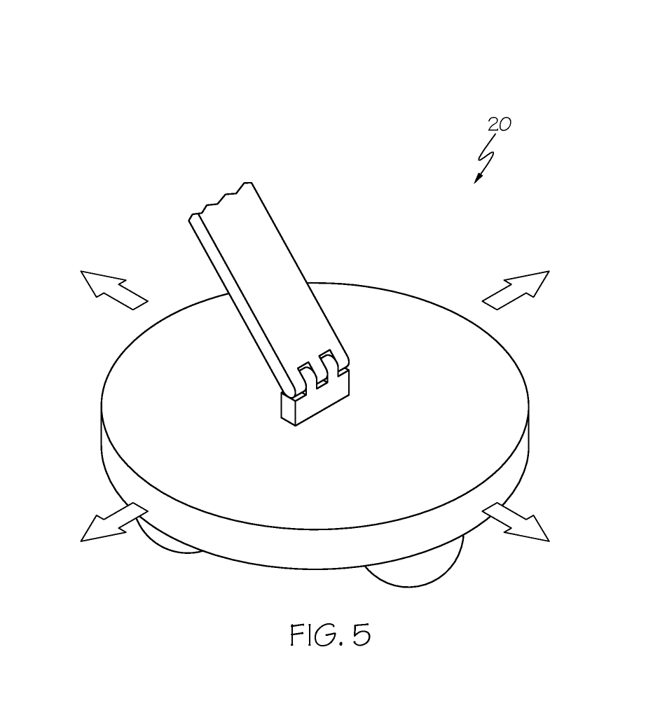

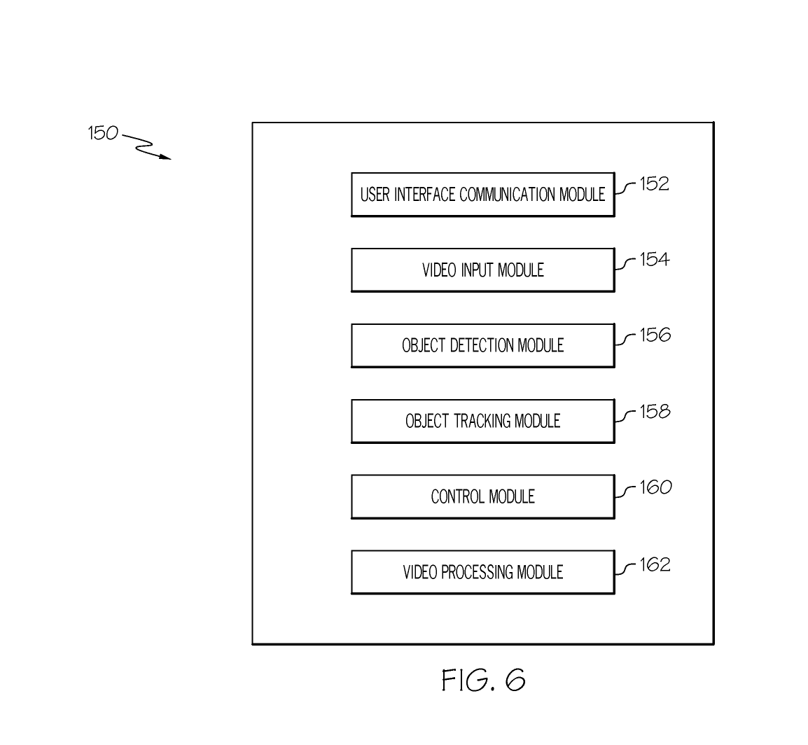

FIG. 2 shows a schematic diagram illustrating a robotic self-filming system according to an example embodiment of the present invention. FIG. 2 shows a preferred embodiment of a robotic self-filming apparatus (RSFA) 5. In such a preferred embodiment, RSFA 5 includes base 20, robot arm 30, video recording device (VRD) holder 45, and interface unit 50. As shown, an integrated video recording device (VRD) 10 (e.g., camera, smartphone, etc.) is mounted on VRD holder 45. RSFA 5 may include a robot control unit 150 enable to interface with interface unit 50. In one example, robot control unit 150 may be integrated into base 20. In other examples, robot control unit 150 may be located in a different component of RSFA 5. Robot control unit 150 may be further enable to communicate requests to components of RSFA 5, such as base 20 and robot arm 30. For example, robot control unit 150 may communicate movement requests to RSFA 5 when video recording an object based on a set of predefined parameters and any movements made by the object. The functions of the robot control unit will be discussed in greater detail below with reference to FIGS. 5-6. Communication unit 155 may be configured to communicate with a server for performing at least one of downloading control software or uploading a video.

RSFA 5 is portable so that it may be taken to and set up at a recording venue. RSFA 5 is configured to detect and track an object (not shown) as the object moves freely in an environment. A user may wish to record a particular person or the user himself or herself. As used herein, the person being recorded is referred to as the “object”. RSFA 5 may be used to record a lecture, interview, video diary, music video, or the like. It is noted that the object may any animate or inanimate object.

Robot arm 30 is coupled to base 20 by motorized rotation member 35. Rotation member 35 allows robot arm 30 to rotate up to 360 degrees about base 20. In addition, VRD holder 45 may be separately configured to rotate up to 360 degrees about robot arm 30. Robot arm 30 includes one or more motorized joints 40 having a pivotal axis allowing the robot arm 30 to move in any direction relative to base 20. The robot arm is motorized to move like a human arm in order to obtain optimal composition based on the selected shooting mode, along with the object detection and tracking results. To obtain various and flexible composition using the robot arm, the robot arm may have any number of degrees of freedom. Although six degrees of freedom is theoretically optimal, for some applications, the robot arm 30 can be controlled with less than six degrees of freedom. These features allow RSFA 5 to pan and tilt such that VRD 10 points at the object and remains pointed at the object during video recording as he or she moves. The components of RSFA 5 may be configured and integrated in a number of different ways. Some components (i.e., base 20, robot arm 30, rotation member 35) are preferably formed from steel but various materials (e.g., plastic, ceramic, etc.) may be used.

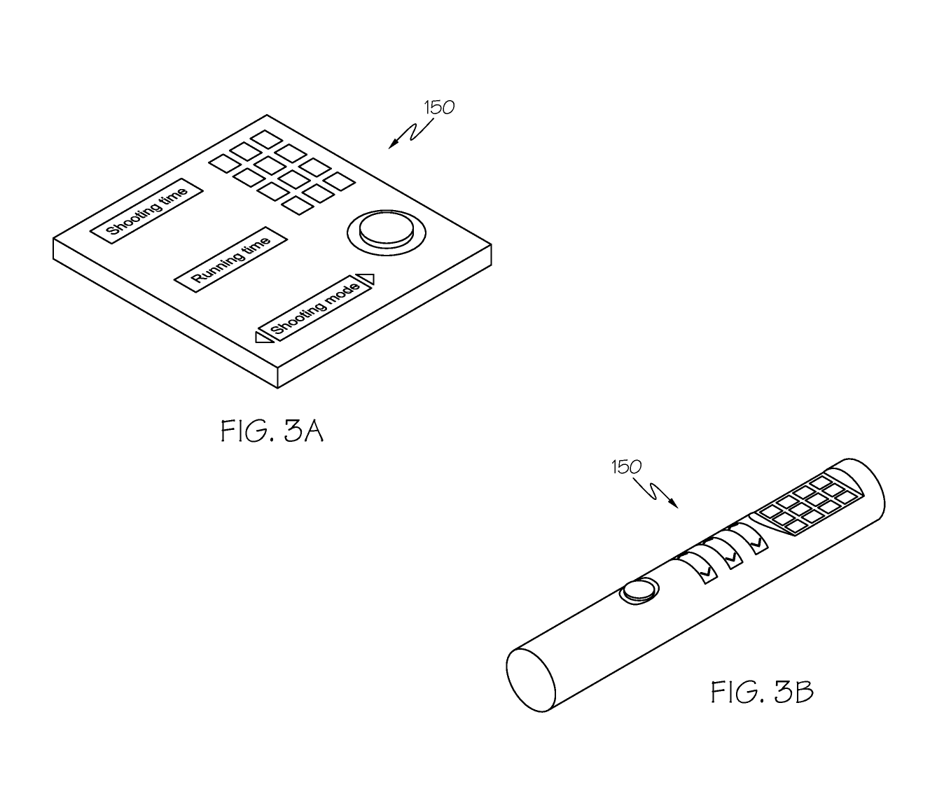

FIGS. 3A-B show schematic diagrams illustrating example graphical user interfaces according to embodiments of the present invention. FIG. 3A shows a first example embodiment of a user interface 50. FIG. 3B shows a second example embodiment of a user interface 50. In such embodiments, user interface 50 is used to define a set of parameters to be used during video recording. For example, user interface 50 may allow input via number pad for a shooting time and running time. The running time may be shorter duration than the shooting time. The running time represents the total elapsed time of a final video product that the user wishes to create. The shooting time represents the total elapsed time of a current video recording session. For example, a teacher may wish to create a final video product lasting 1 hour (i.e., running time) showing selected scenes from compiled recorded video of different practice lectures having total elapse time of 2 hours (i.e., shooting time). The user may also select a shooting mode based on the type of event being recorded. For example, for recording party, the shooting mode may be defined so as to include as many as people in the party as possible having fun. For an online education video, the shooting mode may be defines so that the camera moves slowly and includes a teacher's writing on a whiteboard. For surveillance, the shooting mode may defined to a moving object in a monitoring area. As shown, the user may scroll through various available shooting modes until one is selected for use. In addition, user interface 50 may include means for beginning the video recording session (e.g., “start” button).

User interface 50 can implemented using a touch pad (FIG. 3A), smartphone, personal computer (PC), tablet PC, bar-type device (FIG. 3B), or other device type capable of defining a set of parameters to be used during video recording. User interface 50 may also include menus and multiple screens, windows, or panels, buttons, joysticks, touchscreens, and other user input devices present receive operator control input, which is processed and transmitted to the robot according to one or more communications protocols between the user interface 50 and the robot control unit 150. User interface 50 may comprise a one or more of a wireless (e.g., Wi-Fi, Bluetooth, and/or cellular data, etc.), a wired network connection (e.g., HDMI, Ethernet, etc.), and serial data connections (e.g., USB, Firewire, Thunderbolt, etc.) to communicate with robot control unit 150.

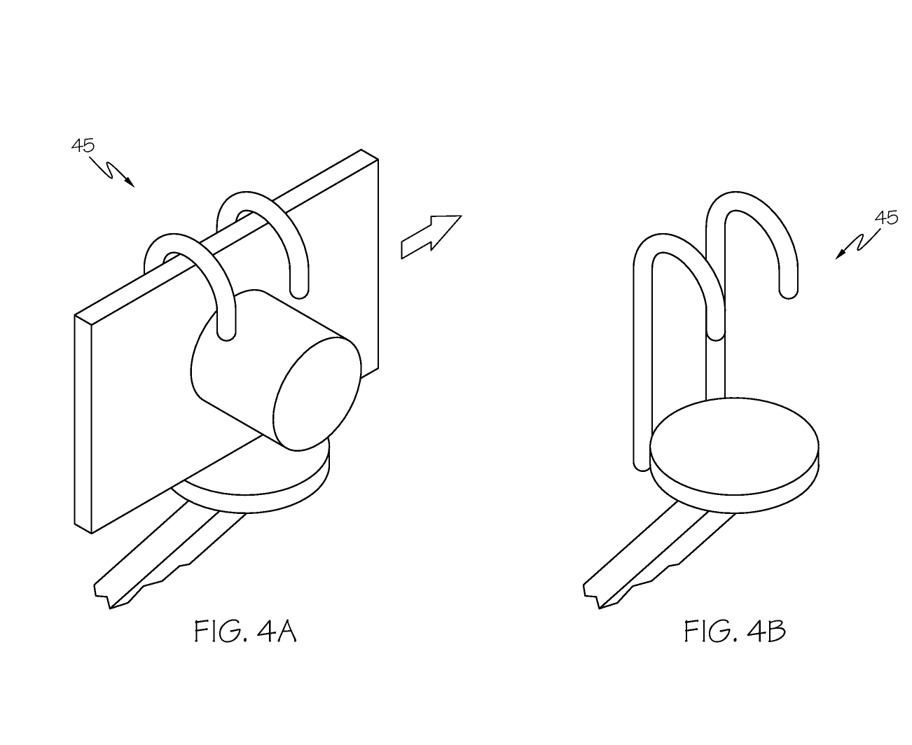

FIGS. 4A-B show schematic diagrams illustrating removal of a video recording device from a video recording device holder according to example embodiments of the present invention. FIG. 4A shows a preferred embodiment of a VRD holder 45 with an external (i.e., non-integrated) camera 10. In some embodiments, video recording device 10 may be integrated into VRD holder 45. In other embodiments, such as FIG. 4A, video recording device 10 may not be “built-in” and must be provided by the user. As shown in FIG. 4A, VRD holder 45 includes couplers (e.g., “fingers”) which help to secure the external camera. FIG. 3B shows VRD holder 45 after the external camera has been removed by simply sliding the camera through the fingers. In other example, VRD holder 45 may include other means for securing an external device such as a clamp, suction cup, screw design, or the like.

FIG. 5 shows a schematic diagram illustrating a robotic self-filming apparatus base according to an example embodiment of the present invention. FIG. 5 shows a preferred embodiment of a base 20 configured to move in any direction. Base 20 can include one or more wheels, rollers, or the like, which allow it to move in one or more directions while tracking and video recording the object. As shown in FIG. 5, base 20 includes multi-directional wheels which allow RSFA 5 to move in any direction in order to continue filming the object when the object moves laterally in such a way that would take the object out of the field of view of video recording device 10.

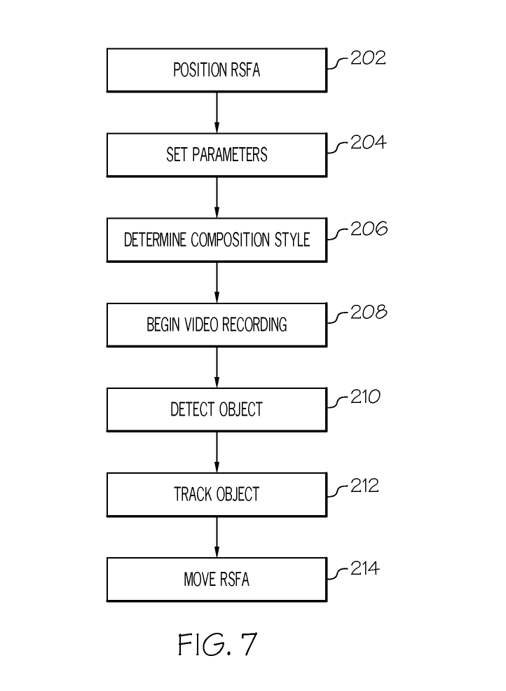

FIG. 6 shows a schematic diagram illustrating a robot control unit of a robotic self-filming according to an example embodiment of the present invention. FIG. 6 shows a preferred embodiment of a robot control unit 150 configured to control movements of RSFA 5 while video recording an object. As shown, robot control unit 150 includes user interface communication module 152, video input module 154, object detection module, object tracking module 158, control module 160, and video processing module 162. The functions of robot control unit 150 will be discussed in detail with reference to FIG. 7 below.

FIG. 7 shows a flow diagram illustrating a method for video recording using a robotic self-filming (RSF) system according to an example embodiment of the present invention. The steps below will be described with reference to the following scenario: a teacher wishes to video record himself doing a “practice” lecture in front of a chalkboard before beginning his new teaching career in order to determine how he can improve his lecturing skills. In this example, the teacher is, himself, the object. At 202, the teacher positions RSFA 5 several feet in front of the chalkboard with camera 10 facing the chalkboard for video recording. At 204, the teacher uses a touch pad user interface 50 to set parameters. The teacher may define a shooting time, a running time, and a shooting mode. Since the class is only 50 minutes long and he will only be recording one video, he enters “50 minutes” for the shooting time and the running time. He enters “lecture” for the shooting mode. The parameters are received by user interface communication module 152.

At 206, a composition style is determined. A composition style may include composition style may include one or more of the following: a camera position, a camera angle, a camera focal length, a level of light sensitivity, a shutter speed, an aperture, a white balance, an image filter, or the like. A set of composition styles may be retrieved from a composition style repository. In one example, user interface 50 may interact with composition style repository and a user may select a composition style from among the set of retrieved composition styles using user interface 50. Composition styles made be stored and retrieved from composition style repository 122. In another example, a composition style may be defaulted based on the selected shooting mode (e.g., lecture, music video, video diary, etc.).

The composition style can be designed by each user according to his/her preference. In one embodiment, a set of suggested or standard composition styles can be pre-designed by other people and made available for download via a web server using communication unit 155. A user can select a particular composition style which he/she prefers before starting to take videos. Some parameters of the downloaded composition style may need to be determined during the installation procedure. The procedure of using a composition style starts with the following three initialization steps.

[Step 1] For one or more target objects, the user may set up the camera so that the target objects can be seen in a single frame. The user may then select the objects as targets, either manually or automatically using object detection module 156. Particularly, for a single target case, the user can set an object in the middle of the scene frame and select it as a target. These target objects will be detected and tracked automatically from then on.

[Step 2] After the target objects are determined, object tracking module 158 tracks the targets based on its features (e.g., face or voice recognition). At the same time, the object tracking module 158 starts to recognize the backgrounds and detects the features of them so that the module generates a feature map. Typical examples of background features include, but are not limited to, edges, corners, colors, brightness, textures, and the like.

[Step 3] Using the obtained feature map of the background, the control module 160 determines the best camera poses with six degrees of freedom (i.e., (x, y, z) coordinates and yaw, roll, pitch angles). Typically, this is done using estimation algorithms known in the art, and these estimate values are used as inputs to the control module 160 which adjusts the actual position of the video recording device 10 as specified in the downloaded composition.

Returning to the example, at 208, the teacher then elects to begin video recording his lecture. To that end, the teacher may press a “start” button on user interface 50, as shown in FIG. 2A.

Robot control unit 150 may interface with user interface 50 and control the functions of RSF 5 including detecting and tracking the movements of an object while video recording the object. At 210, the teacher positions himself in view of camera 10 and robot control unit 150 detects him. Robot control unit 150 interfaces with video recording device 10 to receive and process the video data of the video recording device 10. Robot control unit 150 processes the received video data to detect an object. For example, the teacher is detected using the video data received from the camera. Any number of methods may be used by robot control unit 150 for object detection including, but not limited to, facial recognition, human body detection, writing or painting detection for a teaching or seminar, horizontal line detection, or the like.

Similarly, at 212, robot control unit 150 tracks the object, once detected, using video data received and processed by robot control unit 150. In other words, after a particular person has been detected, robot control unit 150 may communicate movement requests to RSFA 5 based on the selected composition style and any movements made by the object. For example, the robot control unit 150 may request the RSFA 5 to perform various movements such as robot arm actuations to continue tracking the object during video recording as the object freely moves about. In one example, the robot arm 30 may be moved by a motion planning algorithm based on the desired composition, object detection, and/or tracking results.

While tracking, robot control unit 150 may reference the selected composition style to determine any movements needed to be made by RSFA 5 to comply with the determined composition style. In other words, the selected composition style may specify that RSFA 5 must maintain a set distance and angle from object while video recording. In that case, if RSFA 5 is to maintain a set distance from the object and the teacher moves to his left 3 feet while giving his lecture, then robot control unit 150 request RSFA 5 to move 3 feet so as to maintain the set distance. Movements made by RSFA 5 may include robot arm actuations and/or base 20 repositioning. RSFA 5 then performs the movements based on the requests made by robot control unit 150.

In addition, robot control unit 150 preferably computes the distance between VRD 10 and the object and adjusts the focus of VRD 10 so that object remains in focus. Furthermore, robot control unit 150 recognizes whether or not object is close to the edge of the frame of the VRD 10. Such recognition is based on the distance between VRD 10 and the object and is further based on the velocity of object. Accordingly, when the object is close to the edge of the frame of the camera, robot control unit 10 may command VRD 10 to zoom out. Additionally, VRD 10 may be directed to zoom out when the object's location becomes unknown or uncertain. This may occur if, for example, the object is a surfer and he or she is temporarily underneath the surface of the water or behind a wave. When circumstances change, VRD 100 preferably zooms in to record a more detailed picture of the object.

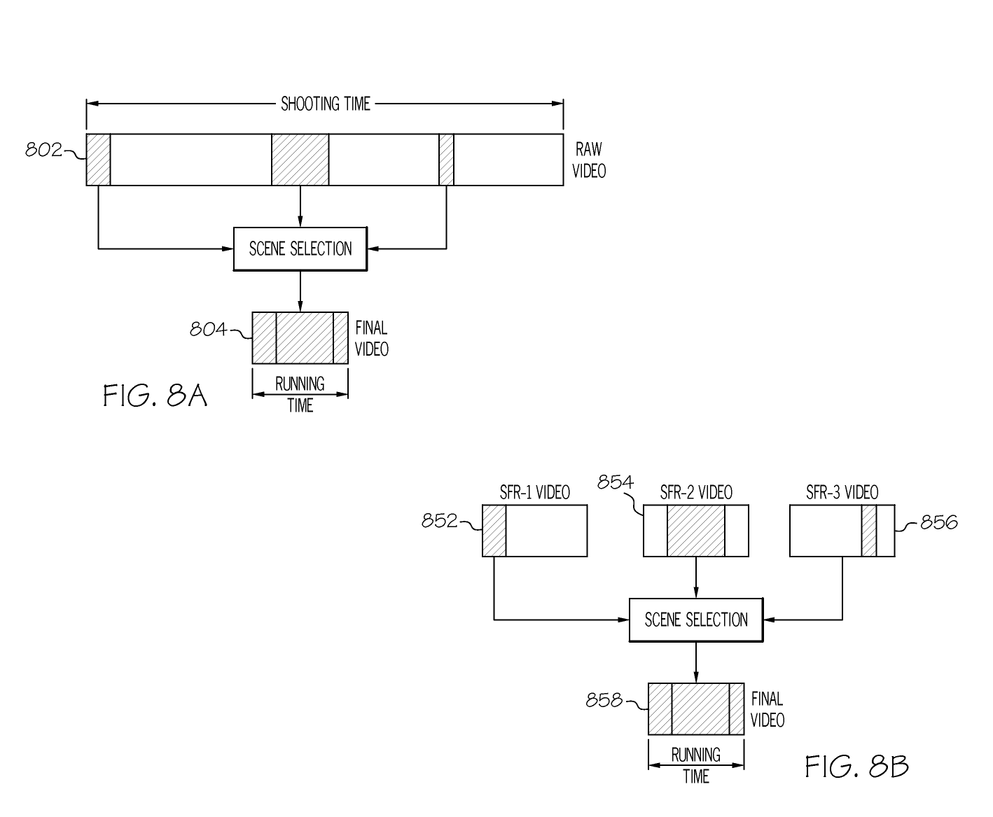

FIGS. 8A-B show schematic diagrams illustrating video processing according to example embodiments of the present invention. FIG. 8A shows a preferred embodiment of automatic video editing performed by video processing module 162 from a single RSF 5. As shown, the user-defined shooting time is longer than the user-defined running time. The shooting time represents the elapsed time of the total recorded, raw video 802 recorded by VRD 10. Video processing module 162 includes scene selection logic that automatically selects scenes from the raw video 802 to produce final video 804.

In one example, final video 804 may include a single, continuous shot. In another example, multiple scenes may be selected to form the final video 804 based on shooting mode, shooting time, and/or running time. For example, scenes that include as many people as possible can be selected for a party shooting mode. In a normal, daily shooting mode, particular scenes can be selected when an object is moving, where the degree of movement can be quantified. In an education shooting mode, scenes can be selected only when the teacher speaks something. According to the degree of movement of scenes, the scenes can also be prioritized. Scenes to be included in the final video 804 may be determined by priority and/or chronological order within the boundary of the predefined running time.

FIG. 8B shows a preferred embodiment of automatic video editing performed by video processing module 162 from multiple RSFAs 5. As shown, video processing module 162 receives recorded video from RSFA-1, RSFA-2, and RSFA-3. Again, the user-defined shooting time is longer than the user-defined running time. The shooting time represents the elapsed time of the total recorded, raw video from the multiple RSFAs 5 (i.e., RSFA-1 video 852, RSFA-2 video 854, and RSFA-3 video 856). Video processing module 162 includes scene selection logic that automatically selects scenes from among the total raw video to produce final video 858.

It will be appreciated that the method process flow diagram of FIG. 7 represents a possible implementation of a process flow for a robotic self-filming system, and that other process flows are possible within the scope of the invention. The method process flow diagram discussed above illustrates the architecture, functionality, and operation of possible implementations of systems, methods, and computer program products according to various embodiments of the present invention. In this regard, each portion of the flowchart may represent a module, segment, or portion of code, which comprises one or more executable instructions for implementing the specified logical function(s). It will also be noted that each block of the flowchart illustration can be implemented by special purpose hardware-based systems that perform the specified functions or acts.

Further, it can be appreciated that the approaches disclosed herein can be used within a computer system for implementing a robotic self-filming system. In this case, as shown in FIG. 1, robot control unit 150 can be provided, and one or more systems for performing the processes described in the invention can be obtained and deployed to computer infrastructure 102 (FIG. 1). To this extent, the deployment can comprise one or more of: (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computer system 104 (FIG. 1) may be described in the general context of computer-executable instructions, such as program modules, being executed by a computer. Generally, program modules include routines, programs, people, components, logic, data structures, and so on, which perform particular tasks or implement particular abstract data types. Exemplary computer system 104 may be practiced in distributed computing environments where tasks are performed by remote processing devices that are linked through a communication network. In a distributed computing environment, program modules may be located in both local and remote computer storage media including memory storage devices.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, robot control unit 150 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (for example, the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet service provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create a means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

It is apparent that there has been provided with this invention an approach for implementing a robotic self-filming system. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for recording a video using a robotic self-filming, the method comprising:
receiving video data from a video recording device;
detecting an object based on the video data;
determining a composition style;
tracking the object based on the video data; and
communicating a movement request to the robotic self-filming based on the tracking and the composition style.

2. The method of claim 1, wherein the robotic self-filming apparatus includes a robot arm and a base.

3. The method of claim 2, wherein the movement request includes at least one of: a robot arm actuation or a base repositioning.

4. The method of claim 3, wherein the object is detected using object recognition.

5. The method of claim 1, further comprising receiving a set of parameters as input from a user interface, wherein the user interface is associated with the robotic self-filming.

6. The method of claim 5, further comprising generating a video output based on the video data and at least one of the set of parameters and composition style.

7. The method of claim 5, wherein the composition style is determined by at least one of downloading from a server or generating by a user.

8. A robotic self-filming system, comprising:
a robotic self-filming apparatus having:
a base;
a robot arm; and
a video recording device holder configured to hold a video recording device; and
a robot control unit, configured to:
receive video data from the video recording device;
detect an object based on the video data;
determine a composition style;
track the object based on the video data; and
communicate a movement request to a robotic self-filming apparatus based on the tracking and the composition style; and
a communication unit, configured to communicate with a server for performing at least one of downloading control software or uploading a video.

9. The system of claim 8, wherein the robot arm includes at least one motorized joint, wherein each motorized joint of the one or more motorized joints includes a pivotal axis configured to allow the robot arm to move in a direction relative to the base.

10. The system of claim 9, wherein the movement request includes a robot arm actuation, wherein the robot arm actuation includes operating at least of the one or more motorized joints.

11. The system of claim 8, wherein the object is detected using object recognition.

12. The system of claim 8, further including a user interface configured to receive a set of parameters as input, wherein the user interface is configured to communicate with the robot control unit.

13. The system of claim 12, wherein the video recording device records video in an automatic mode or a manual mode, wherein the manual mode is associated with one or more parameter settings within the set of parameters.

14. The system of claim 13, wherein at least one parameter setting within the set of parameters is associated with a running time, a shooting time, a shooting mode, a composition style, or a robot arm movement.

15. The system of claim 14, wherein the robot control unit is further configured to generate a video output based on the video data and at least one of the set of parameters and composition style.

16. The system of claim 8, wherein the base includes one or more wheels or rollers allowing the base to move in a direction.

17. The system of claim 8, wherein the movement request includes a base repositioning.

18. The system of claim 8, wherein the composition style may include at least one of a camera position, a camera angle, a camera focal length, a level of light sensitivity, a shutter speed, an aperture, a white balance, or an image filter.

19. The system of claim 18, wherein the composition style may be retrieved from a set of composition styles stored in a composition style repository.

20. The system of claim 8, wherein the user interface is at least one of: a touch pad, smartphone, personal computer (PC), tablet PC, or bar-type device.
